(19) United States
(12) Patent Application Publication
(10) Pub. No.: US 2015/0271371 A1
(43) Pub. Date: Sep. 24, 2015

(54) USER DEVICE WITH LASER ETCHED CAMOUFLAGE SENSOR APERTURE

(71) Applicant: MOTOROLA MOBILITY LLC, Chicago, IL (US)

(72) Inventors: David R. Vogel, Gurnee, IL (US); Ralph G. Cory, Wauconda, IL (US); Ali Javan Javidan, Sunnyvale, CA (US)

(73) Assignee: MOTOROLA MOBILITY LLC, Chicago, IL (US)

(21) Appl. No.: 14/282,045

(22) Filed: May 20, 2014

Related U.S. Application Data
(60) Provisional application No. 61/954,837, filed on Mar. 18, 2014.

(51) Int. Cl. H04N 5/225; B23K 26/38

(52) U.S. Cl. CPC H04N 5/2254; H04N 5/2257; B23K 26/385

(57) ABSTRACT

A user device and method are provided for visually camouflaging a lens. A housing of the user device having at least one outer layer of opaque material with a pattern of small holes laser etched into the at least one outer layer of opaque material. A sensor is attached behind the pattern of small holes. A processor in communication with the sensor detects an image through the pattern of small holes. In one embodiment, each of the small holes has a dimension that is less than is humanly visible such as between 5-10 μm. All or a subset of the holes may pass completely through the opaque material. A second subset of holes may each be to a selective depth in the opaque material, such as opaque material having layers of different colors, to form a camouflage pattern.

### BACKGROUND

1. Technical Field

The present disclosure generally relates to user devices, and more particularly to user devices including an integral sensor having a lens.

2. Description of the Related Art

In addition to desktop device, mobile devices such as cellular telephones, smart phones, and other handheld or user electronic devices such as personal digital assistants (PDAs), headsets, tablets, MP3 players, etc. have become popular and ubiquitous. As more and more features have been added to desktop and mobile devices, there has been an increasing desire to equip these mobile devices with input/output mechanisms that accommodate numerous user commands and/or react to numerous user behaviors. For example, many mobile and desktop user devices are now equipped not only with buttons or keys/keypads, but also with capacitive touch screens that enable a user to communicate a variety of messages or instructions to the mobile device, simply by touching the surface of the mobile device and/or moving the user's finger along the surface of the desktop or mobile device.

Mobile devices have also been equipped with sensors such as infrared (IR) sensor that are capable of detecting the presence of physical objects located outside of the mobile devices and determining, with some accuracy, the position of the physical objects. More particularly, IR sensor detects the presence and location of human beings (or portions of their bodies, such as their heads or hands) who are using the mobile devices or are otherwise located close to the mobile devices. By virtue of such capabilities, the mobile devices are able to adjust the device's behavior in a variety of manners that are appropriate given the presence (or absence) and location of the human beings and/or other physical objects.

Adding IR sensors requires a sufficient aperture through a housing of the mobile device in order to detect a gesture by a user, for example. Providing such apertures runs counter to other design objectives and user preferences, such as the aesthetic look of the mobile device. Increasingly, original equipment manufacturers (OEM) seek an uninterrupted appearance of the mobile device for either a simple utilitarian appearance or as an uncomplicated surface to accept personalized decorations. Users often prefer to have decorations applied directly to the housing of the mobile device. To that end, layers of ink may be applied to a metal or polymer substrate during manufacture to achieve a desired effect. Forming a large aperture through the layers of ink and the substrate that is clearly visible tends to compromise this desired effect.

### BRIEF DESCRIPTION OF THE DRAWINGS

The description of the illustrative embodiments is to be read in conjunction with the accompanying drawings, wherein:

FIG. 1 illustrates a block diagram of an example user device having a camouflaged sensor aperture and within which various aspects of the disclosure can be implemented, according to one or more embodiments;

FIG. 2 illustrates a front depiction of an example user device having a camouflaged sensor aperture, according to one embodiment;

FIG. 3 illustrates a detail view of a camouflaged sensor aperture of fully laser-etched small holes through an opaque material of the example user device of FIG. 1, according to one embodiment;

FIG. 4 illustrates a detail view of a camouflaged sensor aperture of fully and partially laser-etched small holes in an opaque material of the example user device of FIG. 1, according to one embodiment;

FIG. 5 illustrates a cross sectional view of the camouflaged sensor aperture along lines A-A of FIG. 2, according to one embodiment;

FIG. 6 illustrates a flow diagram of a method for visually camouflaging a lens formed in a user device, according to one embodiment;

FIG. 7 illustrates a flow diagram of a method for visually camouflaging the lens using fully and partially laser etched holes, according to one embodiment; and

FIG. 8 illustrates a flow diagram of a method for visually camouflaging the lens using fully and partially laser etched holes in multiple layer opaque material, according to one embodiment.

### DETAILED DESCRIPTION

The illustrative embodiments of the present disclosure provide a method for visually camouflaging a lens of a user device. The method includes forming a housing having at least one outer layer of opaque material. The method includes laser etching a pattern of small holes into the at least one outer layer of opaque material. The method includes attaching a sensor behind the pattern of small holes. The method further includes detecting, by the sensor, an image through the pattern of small holes.

In one or more embodiments of the present disclosure, a user device is provided that has a visually camouflaged lens. The user device includes a housing having at least one outer layer of opaque material with a pattern of small holes that are laser etched into the at least one outer layer of opaque material. A sensor is attached behind the pattern of small holes. A processor in communication with the sensor detects an image through the pattern of small holes.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present disclosure. The following detailed description is, therefore, not to be taken in a limiting sense, and the scope of the present disclosure is defined by the appended claims and equivalents thereof.

Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention.

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein.

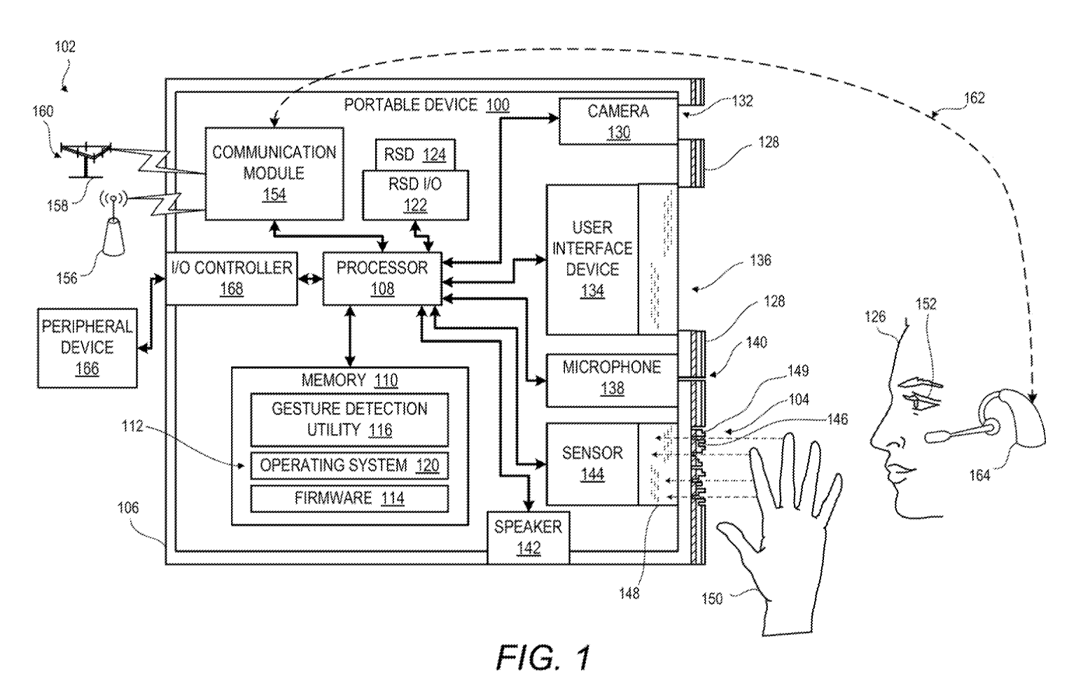

Turning now to FIG. 1, there is depicted a block diagram representation of an example user device 100 within which several of the features of the disclosure can be implemented. In an exemplary aspect, the user device 100 includes the hardware and software to support the various wireless or wired communication functions as part of a communication system 102. According to the general illustration, the user device 100 includes components that require access to the external environment for sensing imagery, such as visual and infrared (IR) images. The user device 100 can be one of a host of different types of devices, including but not limited to, a mobile cellular phone or smart-phone, a laptop, a net-book, an ultra-book, and/or a tablet computing device. The user device 100 may be portable or fixed. Although supporting various functions appropriate for a user device, the user device 100 also mitigates the appearance of such utilitarian features by incorporating laser-etched transmissive and camouflage patterns 104 to a housing 106.

Laser ablation, etching or drilling is the process of removing material from a solid surface by irradiating it with a laser beam. At low laser flux, the material is heated by the absorbed laser energy and evaporates or sublimates. At high laser flux, the material is typically converted to a plasma. Usually, laser ablation refers to removing material with a pulsed laser, but it is possible to ablate material with a continuous wave laser beam if the laser intensity is high enough. The depth over which the laser energy is absorbed, and thus the amount of material removed by a single laser pulse, depends on the material's optical properties and the laser wavelength and pulse length. The total mass ablated from the target per laser pulse is usually referred to as ablation rate. Laser pulses can vary over a very wide range of duration (milliseconds to femtoseconds) and fluxes, and can be precisely controlled.

Referring now to the specific component makeup and the associated functionality of the presented components, the user device 100 can include a processor integrated circuit (IC) 108, which connects via a plurality of bus interconnects (illustrated by the bi-directional arrows) to a plurality of functional components of the user device 100. Processor IC 108 can include one or more programmable microprocessors, such as a data processor and a digital signal processor (DSP), which may both be integrated into a single processing device, in some embodiments. The processor IC 108 controls the communication, user interface, and other functions and/or operations of the user device 100. These functions and/or operations thus include, but are not limited to, application data processing and signal processing. The user device may use hardware component equivalents such as special purpose hardware, dedicated processors, general purpose computers, microprocessor-based computers, micro-controllers, optical computers, analog computers, dedicated processors and/or dedicated hard wired logic. Connected to processor IC 108 is memory 110, which can include volatile memory and/or non-volatile memory, that stores software 112 and/or firmware 114. One or more executable applications can be stored within memory 110 for execution by the processor IC 108. For example, memory 110 is illustrated as containing gesture detection utility 116 and an operating system 120. The memory 110 may be augmented by data storage, illustrated as a removable storage device (RSD) input/output (I/O) interface 122 that receives an RSD 124.

In one embodiment, the housing 106 of the user device 100 supports and protects the aforementioned electronic components while facilitating interactions with a user 126. Certain interactions with the user 126 are made through a front face 128 of the user device 100. In particular, the user device 100 includes one or more I/O devices that require openings in the housing 106, and more often in the front face 128. For example, the user device 100 may include a camera 130 that captures images through a camera aperture 132 in the front face 128. At least one user interface (UI) device 134 is presented through a UI opening 136. For clarity the UI device 134 is a touch screen device. Other embodiments of the user device 100 may include UI devices such as touch pads, graphical or alphanumeric displays, keypads, or haptic devices. The user device 100 may include audio devices such as a microphone 138 having a microphone hole 140 through the front face 128 and a speaker 142 exposed through the housing 106.

The present innovation recognizes one or more opportunities to camouflage certain apertures in the housing 106 given the particular electromagnetic wavelength band utilized by a sensor. In particular, a sensor 144, such as one that detects visual or infrared (IR) imagery, may require an effective aperture that may be made visually small by being formed from many small holes 146 through the housing 106, such as formed by ablation by a laser etching machine wavelength tuned to not damage a lens 148. In addition to making the small holes 146 for transmission nearly invisible, the user device 100 may include the laser etched transmissive and camouflage patterns 104 that further mitigate any aesthetic disruptions in an appearance of the front face 128. In one embodiment, the front face 128 includes opaque layers of deposited ink that may be selectively ablated or etched with small holes 149 fully through as a transmissive pattern or partially through as a camouflage pattern. Transmissive patterns that use nearly invisible small holes 149 and that leave a large portion of opaque layers can also serve as a camouflage pattern. The effective aperture of the laser-etched transmissive and camouflage patterns 104 may thus allow the gesture detection utility 116 to detect movements of a hand 150 of the user 126 yet be nearly invisible to the eye 152 of the user 126. For example, the laser-etched transmissive and camouflage patterns 104 may include holes of 5 to 10 μm.

In an exemplary embodiment, the user device 100 supports wireless communication via a communication module 154. For example, the user device 100 may support communication protocols and transceiver radio frequencies appropriate for a wireless local area network (WLAN), illustrated as a node 156, a radio access network (RAN) 158 of a wireless wide area network (WWAN) or cellular network 160, and a near field or personal access network (PAN) 162, illustrated as a BLUETOOTH headset device 164. In certain embodiments, the user device 100 may also support a hardwired local access network (LAN) or peripheral devices 166 via an I/O controller 168.

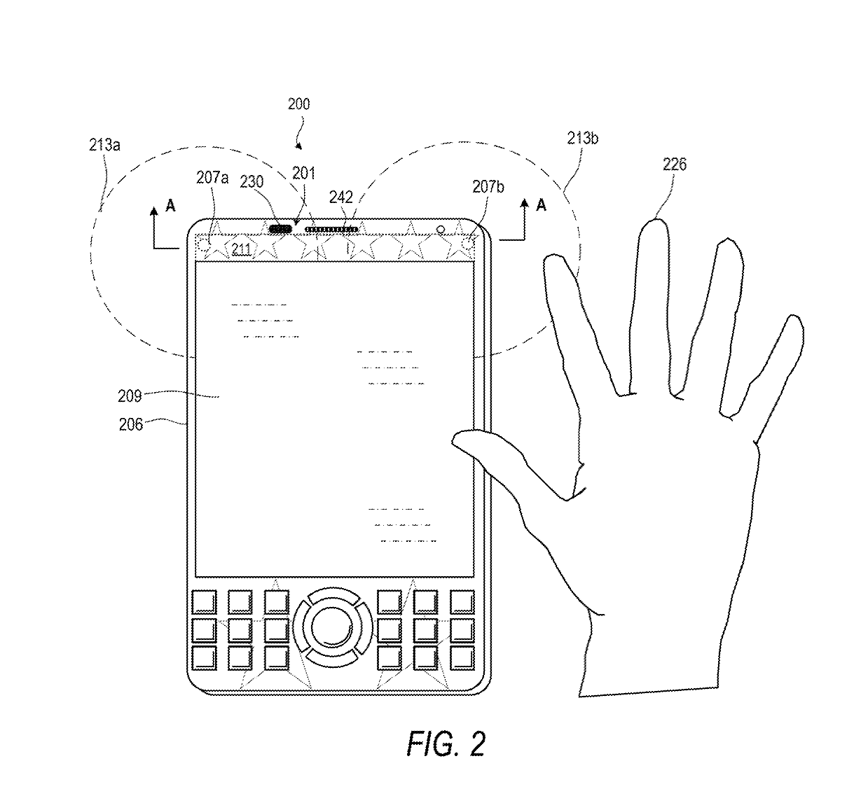

FIG. 2 illustrates a user device 200 having at least one outer layer of opaque material 201 that provides an aesthetic appearance to a housing 206. Large openings in the opaque material 201 and housing 206 are provided for certain components such as for a camera 230 and for a speaker 242. Where possible, nearly invisible sensor apertures 207a, 207b are formed in the opaque material 201 for sensors that can utilize a “screen door” type of aperture. For example, a clear protective surface 209 of glass or polymer can be provided over the top of display or touch elements. An example of clear protective surface 209 is CORNING® GORILLA® glass. The clear protective surface 209 may serve as a lens for certain sensors in addition to serving as part of a touch screen. The opaque material 201 may be applied to the clear protective surface 209 in a covered portion 211 through which the nearly invisible sensor apertures 207a, 207b are laser ablated, etched or drilled. For example, each nearly invisible sensor aperture 207a, 207b may provide a respective image detection area 213a, 213b for detecting a portion of a user 226.

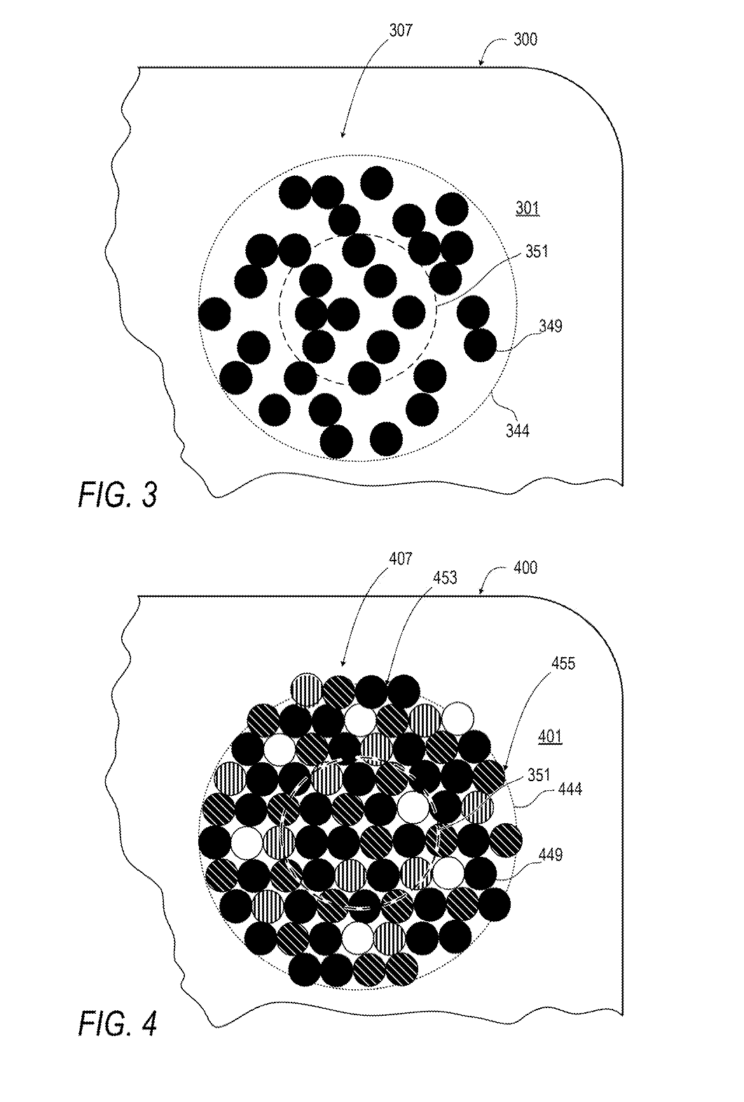

FIG. 3 illustrates one embodiment of a user device 300 having a nearly invisible sensor aperture 307 formed by a pattern of small holes 349 that all pass through an outer layer of opaque material 301. The aggregate area of each small hole 349 forms an effective aperture 351. The number and respective size of the pattern of small holes 349 is computed or empirically determined to allow sufficient energy for a sensor 344.

FIG. 4 illustrates one embodiment of a user device 400 having a nearly invisible sensor aperture 407 formed by a pattern of small holes 449 where a first subset 453 of small holes 449 pass entirely through an outer layer of opaque material 401 to provides an effective aperture 451. A second subset 455 of small holes 449 pass partially through the outer layer of opaque material 401 to form a camouflage pattern 457.

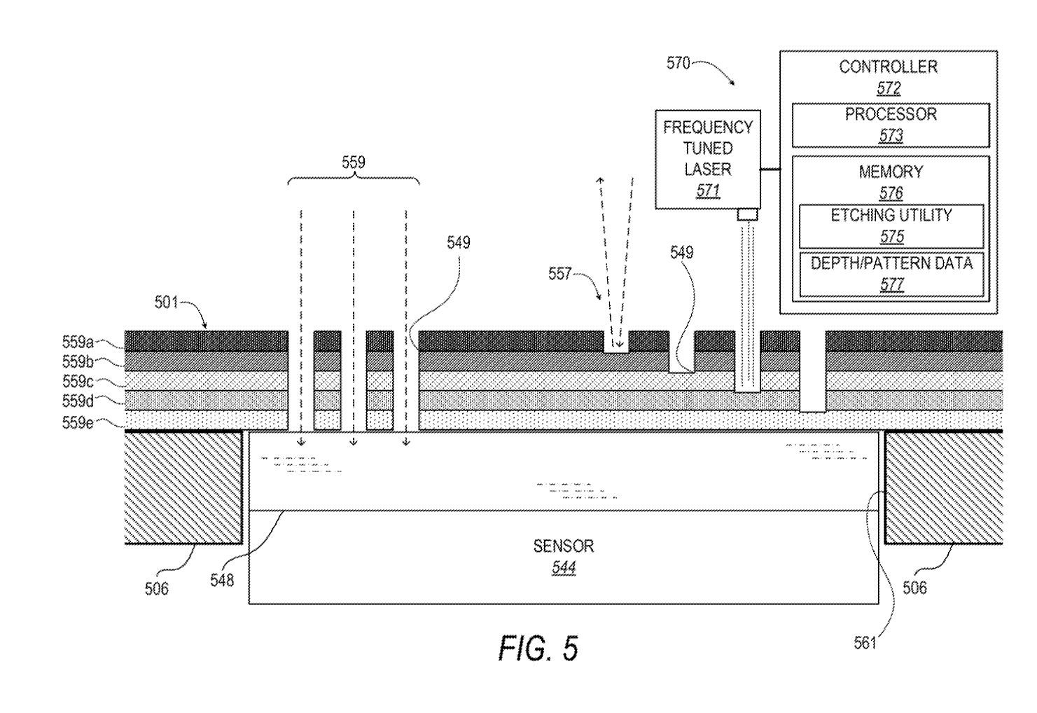

FIG. 5 illustrates both a transmissive-only pattern 559 of small holes 549 that are laser etched through an outer layer of opaque material 501 and a camouflage pattern 557 of small holes 549 partially laser etched through the opaque material 501. In one embodiment, the outer layer of opaque material 501 includes an exposed layer 559a of a first color, a first hidden layer 559b of a second color, a second hidden layer 559c of a third color, a third hidden layer 559d of a fourth color, and a fourth hidden layer 559e of a fifth color. The colors can be any hue, shade, tint, or tone to include black and white. For clarity, the layers extend fully over a lens 548 of a sensor 544 that is mounted within an opening 561 in a housing 506. However, the layers 559a-559e may be individually discontinuous in forming certain aesthetic designs.

A laser etching machine 570 can have a frequency tuned laser 571 that is actuated and controlled by a controller 572. For example, a processor 573 of the controller 572 can execute an etching utility 575 contained in memory 576 to create the transmissive-only pattern 559 and the camouflage pattern 557 in accordance with a depth/pattern data 577 also contained in memory 576. In one embodiment, selectively drilling down to a particular color for the camouflage pattern 557 can visually blend with a particular color that is apparent from the transmissive-only pattern 559. For example, dark contrast can be offset to a degree by a light contrast.

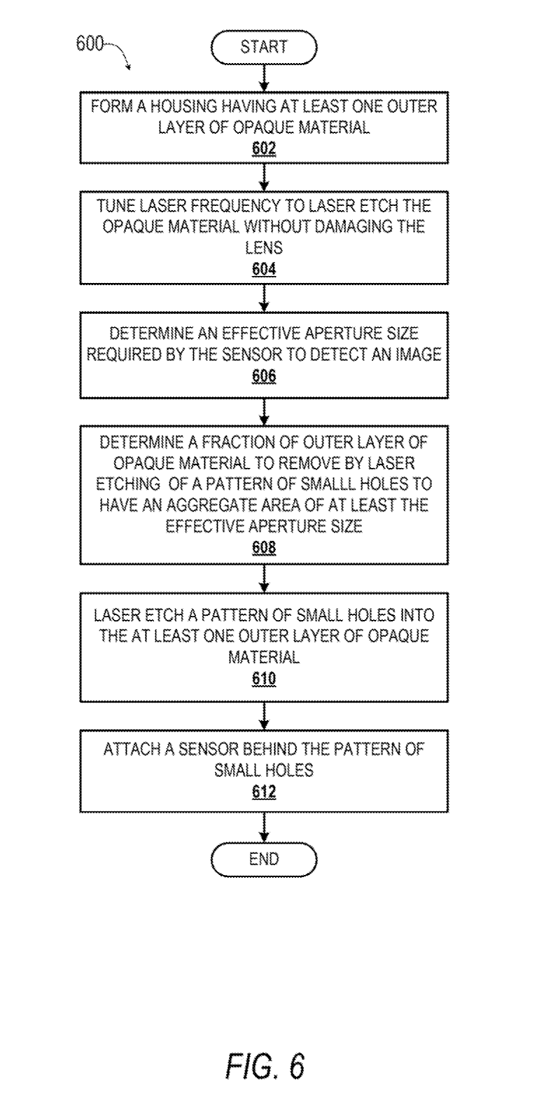

FIG. 6 illustrates a method 600 for visually camouflaging a lens of a user device. Method 600 begins at start block. In one embodiment, the method 600 includes forming a housing having at least one outer layer of opaque material (block 602). In one embodiment, a lens is attached to a substrate that is transparent at a bandwidth detectable by the sensor and the lens is covered by the at least one outer layer of opaque material. The method 600 includes tuning a laser frequency to laser etch the layer of opaque material without damaging the lens (block 604). The method 600 includes determining an effective aperture size required by the sensor to detect an image such as of a portion of a user (block 606). The method 600 includes determining a fraction of the at least one outer layer of opaque material to remove by laser etching of the pattern of small holes to have an aggregate area of at least the effective aperture size (block 608). In block 610, the method 600 includes laser etching a pattern of small holes into the at least one outer layer of opaque material. In one embodiment, the method 600 includes laser etching the pattern of small holes by forming holes having a dimension that is less than is humanly visible. In a particular embodiment, the method 600 further includes forming holes by controlling a laser to form holes each having a diameter between 5-10 μm. In one embodiment, an amount of the at least one outer layer of opaque material that remains without being laser etched provides camouflage. The method 600 includes attaching a sensor behind the pattern of small holes (block 612). Then, method 600 ends.

In use, the lens of the user device that is camouflaged by method 600 can detect an image through the pattern of small holes. For example, the lens can detect an infrared image of a portion of a user of the user device through the pattern of small holes.

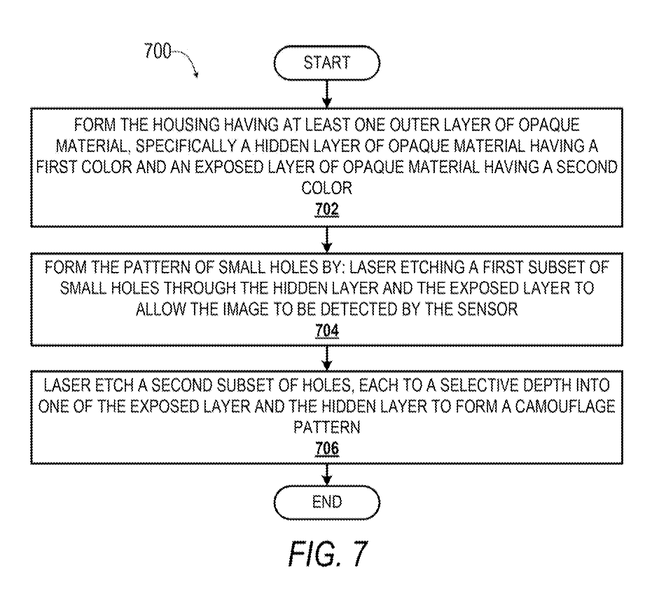

FIG. 7 illustrates a method 700 of forming a camouflage pattern of partially laser etched holes. In one embodiment, the method 700 includes forming the housing having at least one outer layer of opaque material, specifically a hidden layer of opaque material having a first color and an exposed layer of opaque material having a second color (block 702). The method 700 further includes forming the pattern of small holes by: laser etching a first subset of small holes through the hidden layer and the exposed layer to allow the image to be detected by the sensor (block 704). The method 700 includes laser etching a second subset of holes, each to a selective depth into one of the exposed layer and the hidden layer to form a camouflage pattern (block 706).

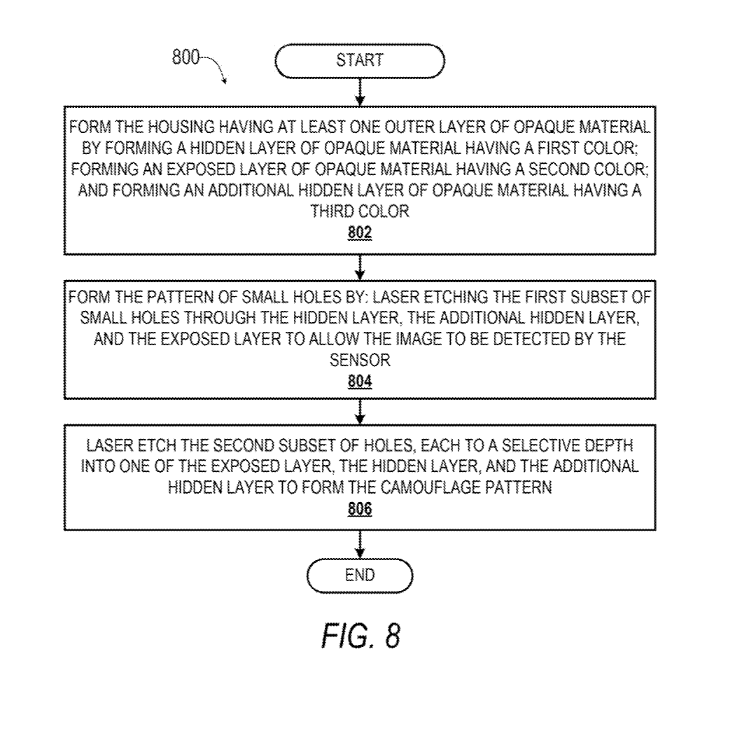

FIG. 8 illustrates a method 800 of forming a camouflage pattern of partially laser etched holes in a multi-layer opaque material. In one embodiment, the method 800 includes forming the housing having at least one outer layer of opaque material by forming a hidden layer of opaque material having a first color; forming an exposed layer of opaque material having a second color; and forming an additional hidden layer of opaque material having a third color (block 802). The method 800 further includes forming the pattern of small holes by: laser etching the first subset of small holes through the hidden layer, the additional hidden layer, and the exposed layer to allow the image to be detected by the sensor (block 804). The method 800 further includes laser etching the second subset of holes, each to a selective depth into one of the exposed layer, the hidden layer, and the additional hidden layer to form the camouflage pattern (block 806).

In each of the flow charts of FIG. 6 presented herein, certain steps of the method can be combined, performed simultaneously or in a different order, or perhaps omitted, without deviating from the spirit and scope of the described innovation. While the method steps are described and illustrated in a particular sequence, use of a specific sequence of steps is not meant to imply any limitations on the innovation. Changes may be made with regards to the sequence of steps without departing from the spirit or scope of the present innovation. Use of a particular sequence is therefore, not to be taken in a limiting sense, and the scope of the present innovation is defined only by the appended claims.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

Aspects of the present innovation are described below with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

While the innovation has been described with reference to exemplary embodiments, it will be understood by those skilled in the art that various changes may be made and equivalents may be substituted for elements thereof without departing from the scope of the innovation. In addition, many modifications may be made to adapt a particular system, device or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description, but is not intended to be exhaustive or limited to the innovation in the form disclosed. Many modifications and variations will be apparent to those of ordinary skill in the art without departing from the scope and spirit of the innovation. The embodiment was chosen and described in order to best explain the principles of the innovation and the practical application, and to enable others of ordinary skill in the art to understand the innovation for various embodiments with various modifications as are suited to the particular use contemplated.

What is claimed is:

1. A method for visually camouflaging a lens of a user device, the method comprising:
forming a housing having at least one outer layer of opaque material;
laser etching a pattern of small holes into the at least one outer layer of opaque material;
attaching a sensor behind the pattern of small holes; and
detecting, by the sensor, an image through the pattern of small holes.

2. The method of claim 1, wherein laser etching the pattern of small holes further comprises forming holes having a dimension that is less than is humanly visible.

3. The method of claim 1, wherein forming holes further comprises controlling a laser to form holes each having a diameter between 5-10 μm.

4. The method of claim 1, wherein:
forming the housing having the at least one outer layer of opaque material comprises:
forming a hidden layer of opaque material having a first color; and forming an exposed layer of opaque material having a second color; and
forming the pattern of small holes comprises: laser etching a first subset of small holes through the hidden layer and the exposed layer to allow the image to be detect by the sensor; and
laser etching a second subset of holes, each to a selective depth into one of the exposed layer and the hidden layer to form a camouflage pattern.

5. The method of claim 1, wherein:
forming the housing having the at least one outer layer of opaque material comprises: forming a hidden layer of opaque material having a first color; forming an exposed layer of opaque material having a second color; and forming an additional hidden layer of opaque material having a third color; and
forming the pattern of small holes further comprises: laser etching the first subset of small holes through the hidden layer, the additional hidden layer, and exposed layer to allow the image to be detect by the sensor; and laser etching the second subset of holes, each to a selective depth into one of the exposed layer, the hidden layer, and the additional hidden layer to form the camouflage pattern.

6. The method of claim 1, wherein detecting the image by the sensor comprises detecting an infrared image of a portion of a user of the user device through the pattern of small holes.

7. The method of claim 1, further comprising:
determining an effective aperture size required by the sensor to detect the image;
determining a fraction of the at least one outer layer of opaque material to remove by laser etching of the pattern of small holes to have an aggregate area of at least the effective aperture size; and
laser etching the pattern of small holes to provide the aggregate area.

8. The method of claim 1, wherein:
forming the housing having at least one outer layer of opaque material comprises attaching a lens to a substrate that is transparent at a bandwidth detectable by the sensor, the lens covered by the layer of opaque material.

9. The method of claim 1, further comprising tuning a laser frequency to laser etch the opaque material without damaging the lens.

10. The method of claim 1, wherein:
forming the housing having the lens comprises applying the at least one outer layer of opaque material to a portion of a touch screen glass that serves as the lens.

11. A user device comprising:
a housing having at least one outer layer of opaque material with a pattern of small holes laser etched into the at least one outer layer of opaque material;
a sensor attached behind the pattern of small holes; and
a processor in communication with the sensor to detect an image through the pattern of small holes.

12. The user device of claim 11, wherein the pattern of small holes comprises holes having a dimension that is less than is humanly visible.

13. The user device of claim 11, wherein the pattern of holes comprises holes each having a diameter between 5-10 μm.

14. The user device of claim 11, wherein:
the at least one outer layer of opaque material comprises: a hidden layer of opaque material having a first color; and an exposed layer of opaque material having a second color; and
the pattern of small holes is formed by: laser etching a first subset of small holes through the hidden layer and the exposed layer to allow the image to be detect by the sensor; and laser etching a second subset of holes, each to a selective depth into one of the exposed layer and the hidden layer to form a camouflage pattern.

15. The user device of claim 11, wherein:
the at least one outer layer of opaque material comprises a hidden layer of opaque material having a first color; an exposed layer of opaque material having a second color, and an additional hidden layer of opaque material having a third color; and
the pattern of small holes is formed by: laser etching the first subset of small holes through the hidden layer, the additional hidden layer, and exposed layer to allow the image to be detect by the sensor; and laser etching the second subset of holes each to a selective depth into one of the exposed layer, the hidden layer, and the additional hidden layer to form the camouflage pattern.

16. The user device of claim 11, wherein the processor is further in communication with the sensor to detect the image by detecting an infrared image of a portion of a user of the user device through the pattern of small holes.

17. The user device of claim 11, wherein an aggregate area of the pattern of small holes is the minimum effective aperture size required by the sensor.

18. The user device of claim 11, wherein the lens comprises a material that is transparent at a bandwidth detectable by the sensor, the lens covered by the layer of opaque material.

19. The user device of claim 11, wherein the pattern of small holes is formed by tuning a laser frequency to laser etch the opaque material without damaging the lens.

20. The user device of claim 11, wherein the lens comprises a portion of a touch screen glass that covers the sensor and a touch screen.
